(19) United States
(12) Patent Application Publication
(10) Pub. No.: US 2007/0055566 A1
(43) Pub. Date: Mar. 8, 2007

(54) System, method, apparatus and computer media for user control of advertising

(75) Inventors: John Gaughan, Buffalo, MN (US); Andrew George Jedynak, Ijamsville, MD (US); Shane Allen Lundy, Montgomery Village, MD (US)

Correspondence Address: OBLON, SPIVAK, MCCLELLAND, MAIER & NEUSTADT, P.C., 1940 DUKE STREET, ALEXANDRIA, VA, 22314, US

(73) Assignee: AWS CONVERGENCE TECHNOLOGIES, INC., Gaithersburg, MD (US)

(21) Appl. No.: 11/217,290

(22) Filed: Sep. 2, 2005

(51) Int. Cl. G06Q 30/00

(52) U.S. Cl. 705/14

(57) ABSTRACT

A system for presenting a user selected advertisement to a user includes a sponsor selector configured to obtain an advertisement selection of the user. The advertisement selection includes at least one user preferred advertising source. The system also includes a sponsor select server that receives the advertisement selection of the user from the sponsor selector and to select a user preferred advertisement based on the user preferred advertising source. In addition, the system includes a content presenter that presents the user preferred advertisement and the multimedia content to the user. A related method, computer program product, sponsor selector apparatus and content presenter apparatus are also presented.

### CROSS-REFERENCE TO RELATED APPLICATION

This patent application is related to co-pending and commonly assigned patent application “Method for User Control of Sponsored Advertising Delivery over Interactive Media,” Ser. No. 10/260,048, filed Sep. 27, 2002, which is incorporated by reference herein in its entirety.

### BACKGROUND OF THE INVENTION

1. Field of the Invention

The present invention relates to a method, system, apparatus and computer program product for allowing a user to select advertising that will be made available to the user on a user interface device.

2. Discussion of the Background

Advertising is commonly added to other content that users wish to experience as a means for generating revenue for the content provider. For example, a video stream is distributed to television users and the video stream includes embedded or interleaved advertising messages. Other types of content that include advertising messages include audio content, for example music or news or discussion on a radio program, static images, for example still images or print images and text on a web site or in a print medium, such as a newspaper or a magazine. In these background content and advertising distribution schemes, various types of content may be combined with a variety of different advertisements from different advertisers or advertising aggregators that collect advertisements from various sources. Further, in each of these background schemes a selection is made either by a publisher of the content or a distributor of the content or an advertiser to provide particular advertising together with particular content. For example, a television distribution channel may decide in concert with advertisers and content providers to place a particular advertisement with a particular content for distribution to users. However, in these background schemes where the selection of advertisements for distribution with particular content is made by someone other than the user, the user commonly perceives the received advertising portion as undesirable or as a necessary evil required to receive the desired content. Accordingly, there is a problem with these background schemes in that the users are less inclined to pay attention to the advertising and may find the content less appealing because of the advertising with which it is distributed.

Furthermore, the conventional advertising schemes according to the background art rely on the broadcasting of information from a single source to many users. This arrangement results in a low likelihood of success with any particular end user. Nevertheless, according to these conventional advertising practices, it is commonplace for an advertiser to select particular programming content to advertise its products. As an example, based on perceived demographics of viewers of American football games, beer and automobile manufacturers typically provide advertisement for football games. The present inventors recognize that over-generalizing the particular viewing (or listening) demographic, based on programming content has a relatively low success rate.

FIG. 18 shows an example of a background scheme of combining content with advertisements. In the example of FIG. 18, content provider A 1806 makes available two types of content over the Internet 1804. In particular, content provider A 1806 makes available content A programmed for advertisements X 1814 and content A2 programmed for advertisements Y 1816. Similarly, content provider B 1808 makes available content B programmed for advertisements X 1818 and content B programmed for advertisements Y 1820. Further in the example of FIG. 18, advertising aggregator 1810 provides plural types of advertising, for example advertisements X1 1822 and advertisements X2 1824. In addition, advertising aggregator Y 1812 provides advertisements Y1 1826 and advertisements Y2 1828.

Further, in this example, content is displayed on, or presented from a user interface 1802, after it is retrieved over the Internet 1804. For example, if a user requests content A from content provider A, content A programmed for advertisements X 1814 may be sent to a user interface available to the user. In addition, the content A is programmed to cause the user interface to also retrieve advertisements X from advertising aggregator X 1810. Thus, the user interface 1802 may also request advertisement A from advertising aggregator X.

Upon receipt of a request for advertisements X, advertising aggregator X 1810 makes a decision to provide at least one of advertisements X1 1822 and advertisements X2 1824 to the user making that request. Thus, in the present example, content on user interface 1802 is displayed as content A plus the advertisement selected by advertisement aggregator X. Alternatively, upon receipt of request for content A by content provider A 1806, content provider A 1806 may choose to send content A programmed for advertisements Y 1816 and subsequently advertising aggregator Y 1812, upon receiving a request for advertisements from the user interface of the user may choose to send advertisements Y1 1820 or advertisements Y2 1828. Thus, in this background example, the user interface 1802 displays or presents a combination of the content requested by the user plus an advertisement selected by the content provider and/or an advertising aggregator.

Thus, in the background scheme of FIG. 18, the selection or advertisements to be displayed with content is made by parties other than the user and therefore the advertising is less effective and the user experience is diminished.

Other background schemes have attempted to address this problem by making an advertisement selection based on general selection information collected about or from the user.

U.S. Pat. No. 5,794,210 is directed to a conventional advertising approach using an “attention brokerage”. In that patent, particular advertisers pay customers directly for their time and attention. Moreover, users are presented with a “Cyber Coin”, which allows advertisers to pay a particular consumer directly for their attention to a particular advertisement. When logging onto a customized home page, the user is presented with a list of ads and those ads are preselected in advance based on a personal profile questionnaire that the user has previously completed. Moreover, the advertising brokerage identifies a list of ads based on the user's profile for the user to pick a particular ad for a browsing session. The user is then paid with cash, credit or coupons representing cash for their attention to that particular ad.

A limitation with this approach, as recognized by the present inventors, is a dependence on financial remuneration of the user. In particular, since a cash or cash equivalent payment is made to the user for watching an ad, the cash payment must be carefully controlled to limit fraud and potentially expensive or complex interfaces with financial institutions (e.g., credit card companies and banks) that are required to manage the payments. Further, that conventional approach is unable to assess an interest of a user because a user selects advertisements to watch based on a monetary value being offered for their attention not based on their interest in that advertisement. Thus, the advertisement is likely to be less effective for those users interested in maximizing their revenue. In addition, that approach requires a user to arrange to sell his or her viewing attention for each different advertisement by clicking on a “cyber coin” prior to viewing the advertisement. Thus, the user is required to make an unnecessary and possibly burdensome additional step prior to seeing each advertisement.

### SUMMARY OF THE INVENTION

The present invention is directed to address the above-identified and other limitations with conventional systems. One attribute of the present invention is that it empowers a user to select predetermined advertisements, advertisers, or categories of advertising so as to receive “consideration” for access to predetermined content. From the user's perspective, the user is provided with free (or subsidized) content through any one of a variety of mediums (e.g., Internet, television, satellite radio, . . . ). From the advertiser's perspective, the advertiser need only pay for content for end users when the end users have expressed a particular interest in their advertisement. Moreover, instead of an advertiser having to pay for a “broadcast” of information to a wide variety of people with varying interests, the advertiser only pays for those individuals who have expressed a particular interest in their products or services.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of an embodiment of the present invention;

FIG. 2 is a block diagram of an embodiment of a user sponsor selector in the present invention;

FIG. 3 is a block diagram of another embodiment of a user sponsor selector in the present invention;

FIG. 4 is a block diagram of another embodiment of a user sponsor selector in the present invention;

FIG. 5 is a block diagram of an embodiment of an enhanced content presenter in the present invention;

FIG. 6 is a block diagram of another embodiment of an enhanced content presenter in the present invention;

FIG. 7 is a block diagram of an embodiment of multimedia content output in the present invention;

FIG. 8 is a block diagram of another embodiment of multimedia content output in the present invention;

FIG. 9 is a block diagram of another embodiment of multimedia content output in the present invention;

FIG. 10 is a block diagram of another embodiment of multimedia content output in the present invention;

FIG. 11 is a block diagram of another embodiment of multimedia content output in the present invention;

FIG. 12 is a block diagram of another embodiment of the present invention;

FIG. 13 is a block diagram of an embodiment of a content distribution system in the present invention;

FIG. 14 is a block diagram of another embodiment of a content distribution system in the present invention;

FIG. 15 is a block diagram of an embodiment of an enhanced content presenter in the present invention;

FIG. 16 is a block diagram of another embodiment of the present invention;

FIG. 17 is a block diagram of an embodiment of a computer used to implement the present invention; and

FIG. 18 is a block diagram of a conventional advertising system.

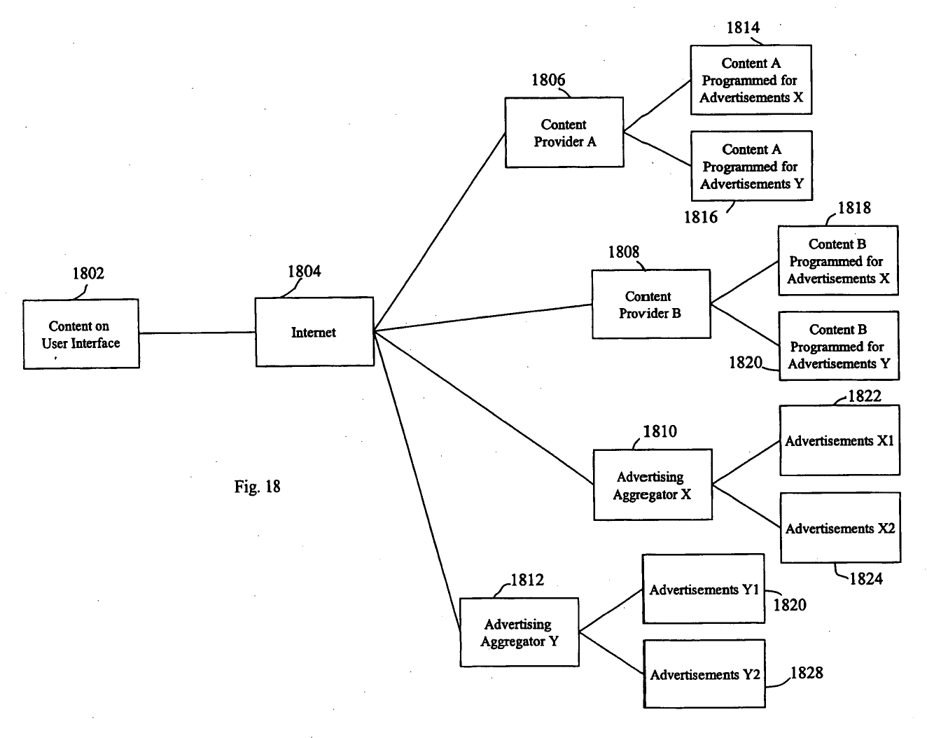

### DESCRIPTION OF THE PREFERRED EMBODIMENTS

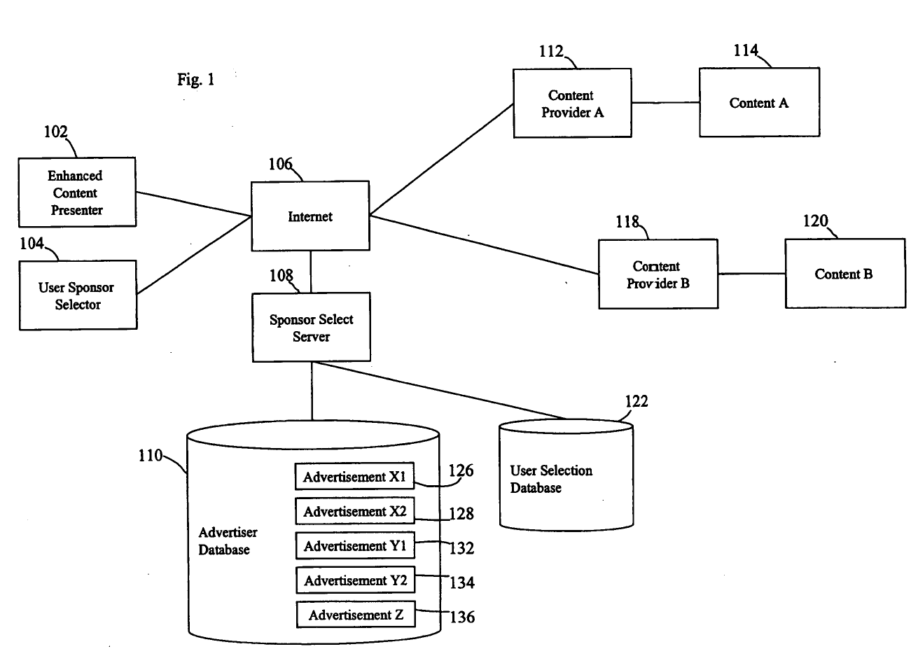

Referring now to the drawings, wherein like reference numerals designate identical or corresponding parts throughout the several views, and more particularly to FIG. 1 thereof, which shows an example of a system for distributing content and advertisements based on user selection. In the example of FIG. 1, a user (not shown) uses an enhanced content presenter 102 and a user sponsor selector 104, each of which are connected via the Internet 106 to plural content providers, for example content provider A 112 and content provider B 118, as well as a sponsor select server 108. The sponsor select server 108 is connected to an advertiser database 110. The advertiser database 110 includes advertisements provided from various sources, including in this example, advertisement X1 126 and advertisement X2 128, from advertising aggregator X (not shown), advertisement Y1 132 and advertisement Y2 134, from an advertising aggregator Y (not shown), and advertisement Z 136.

Using a user sponsor selector 104, the user creates selection information that selects particular advertisers and/or advertisements. The selection information is sent to the sponsor select server 108 over the Internet 106 (or other network). When a user requests content to be displayed on the enhanced content presenter 102, the particular advertisement displayed with the content requested by the user is selected according to the selection information and other information as discussed below.

In particular, if the user requests content A 114 from content provider A 112, and if selection information provided by the user sponsor selector 104 indicates that the user has selected advertisement X1 126 (or selected a particular advertiser or category of advertisement), then the content A is displayed or presented with advertisement X1 126 on the enhanced content presenter 102.

Thus, in the present example, the user indicates a selection for a particular advertisement (advertiser, or category of advertisement) using a sponsor selector and that preferred advertisement is displayed with the content requested by the user. Therefore, the user is more likely to view and use the advertisement, in this example advertisement X1 126, because the advertisement was selected by the user or was selected based on related information such as a particular advertiser or category of advertisement.

As an example, the content may be a television program. In this case, prior to being able to watch the media (for example a pay per view program) the user may be presented with particular advertisements (or advertisers, or categories of advertisement) that the end user views as a precondition to watching the content free of charge or at a subsidized rate.

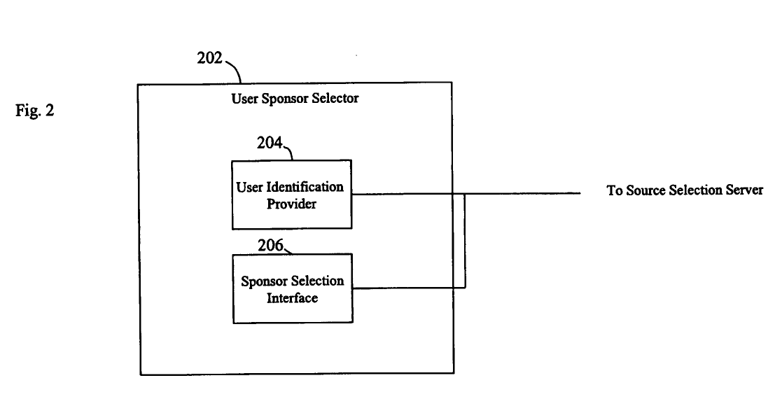

FIG. 2 shows an example of an embodiment of a user sponsor selector 104 from FIG. 1. In the present embodiment, user sponsor selector 202 includes user identification provider 204 and sponsor selection interface 206. The user identification provider 204 provides identification information for the user to the source selection server via the Internet. The user identification may be information that uniquely identifies a human operator, or may be other information, for example information that generally identifies a group or class of human operators (for example, members of a particular club that use a particular computer, travelers that walk near a particular billboard, members of a family, or other classifications of users), or may be information that identifies a particular piece of equipment that hosts the user sponsor selector 202 (e.g., a cookie that identifies a user account on a computer that implements an embodiment of a user sponsor selector).

One of the advantages of the user identification provider 204 is that it allows a mobility component for the user so that previous selections are also applicable on other devices used by the user. For example, if the user makes a selection at his or her personal computer with regard to receiving advertisements from a particular advertiser, that same user when viewing an advertisement on his or her MP3 player, mobile phone, television, and/or navigation system, will observe similar advertisements. This portability aspect of the present invention, enables a selection made by a user for one type of media (e.g., Internet) to be applicable when the user uses a different device and/or different media (e.g., wireless or television).

The user sponsor selector 202 also includes a sponsor selection interface 206 that allows a user to indicate his selected advertiser or category of advertisements that should be displayed with requested content. The user identification information and the sponsor selection are transmitted via the Internet 106 to the sponsor select server 108 and the sponsor select server 108 stores the user identification information and corresponding advertising selection in a user selection database 122. When a user requests content using the enhanced content presenter 102, the content, for example content A, is provided to the enhanced content presenter 102 via content provider A 112 and Internet 106. In addition an advertisement is provided to the enhanced content presenter 102 from the advertiser database 110, via sponsor select server 108 and Internet 106. The advertisement sent to the user is selected based upon advertisements in the advertiser database 110 and user selection stored in the user selection database 122.

Furthermore, the user selection database 122 includes conditional entries. As an example, if the presence of the user is identified at one location using one particular system, for example the navigation system in the person's vehicle, then the category of advertisements or particular advertisements for that particular location are set to be location sensitive. As an example, in the car, the preselected advertisements selected by the user may be restaurants. On the other hand, with respect to television, the selected advertisements may be time-selected, such that in the morning particular news service items are selected, in the afternoon food items, and in the evening financial advertisements.

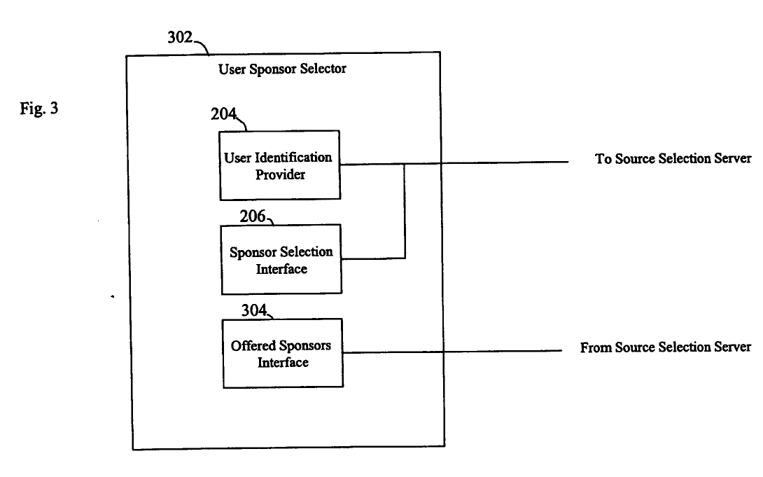

FIG. 3 shows another possible embodiment of a user sponsor selector. In this example user sponsor selector 302 includes user identification provider 204 and sponsor selection interface 206 as in the user sponsor selector 202 of FIG. 2. However, the user sponsor selector 302 also includes an offered sponsors interface 304. The offered sponsors interface 304 presents at least one sponsor or advertising selection from which a user may choose one or more preferred sponsors. For example, the offered sponsors interface 304 may be a display that presents a list of available sponsors or available advertisements. Then, a user may use the sponsor selection interface 206 to indicate an advertisement selection or, for example, to select one sponsor out of the sponsors shown as available sponsors on the offered sponsors interface 304.

Other methods of selecting a selection are also included as part of the present invention. For example, the user may arrange the list of available sponsors or available advertisements in a preferred order indicating those advertisements which are most desirable and those which are less desirable. Alternatively, a user may classify available advertisements or sponsors into desirable and undesirable categories, or other categories. Further, the user may specify conditions in which particular advertisements are preferred and conditions in which other advertisements are not preferred. For example, the user may specify that a particular advertisement is preferred when the user is traveling or away from home, and specify that another advertisement is preferred when the user is located at home. For example, a user may indicate that advertisements regarding restaurants are preferred when the user is more than one mile from a home location and the time is between 4 pm and 7 pm (e.g., dinner time). Further, the selection made by the user may include a particular sponsor (e.g., a particular company offering a particular product), may include a classification of products (e.g., products of a specific type, for example furniture or computers), or may include a specific advertisement (e.g., a humorous animated advertisement from a particular fast food restaurant chain be selected as preferred and a serious or informative advertisement from the same fast food restaurant chain may be indicated as not preferred).

When selecting from the available sponsors or advertisements, the user may be presented with at least one of a textual description of the sponsor, a visual description (e.g., a picture or icon), an audio information (e.g., a “sound bite” that identifies the sponsor), a full-size or reduced size representation of a particular advertisement, a video clip representing the advertisement or the sponsor, or other types of visual and/or audio representations from which the user may select a preferred sponsor, type of sponsor, or particular advertisement.

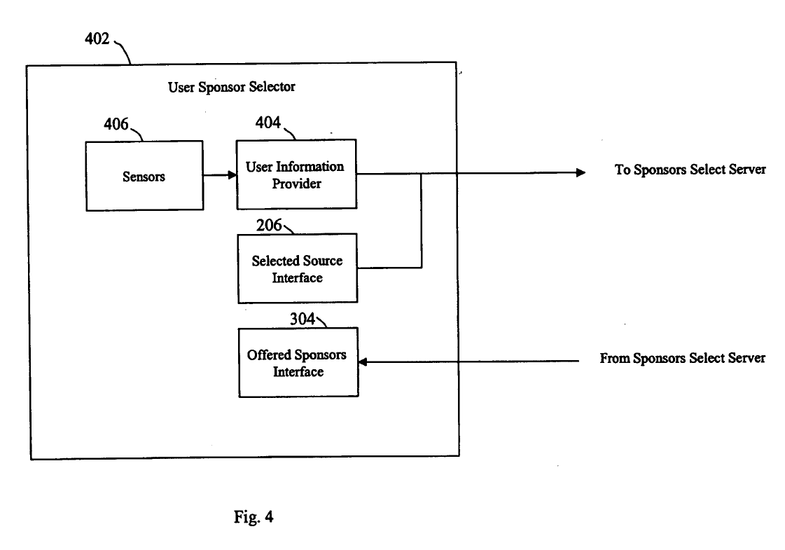

FIG. 4 shows a further embodiment of a user sponsor selector according to the present invention. In FIG. 4, a user sponsor selector 402 includes sponsor selection interface 206 and offered sponsors interface 304 as in the user sponsor selector 302 of FIG. 3. The user sponsor selector 402 also includes user information provider 404 which provides user identification information and also provides sensor information from sensors 406 to the sponsor select server 108. Thus, the user information provider 404 provides user identification information that is stored in user database 122 and further provides sensor data with information regarding the user or the environment the user is in. For example, sensors may include a location sensor (e.g., a GPS receiver) that indicates a current location of a user. The sensor data is not limited to location sensors and also includes other types of sensors like environmental sensors (e.g. temperature, pressure, humidity, etc.), mechanical sensors (e.g. motion detector, trip switch, capacity sensor, etc.) electronic and wireless sensors (infrared, mobile phone, RFID, etc.) or further may include interfaces to other systems or computer information providers that can provide information regarding the user, the user's environment, or the user's status. Further, the sensor data is also stored in the user database 122.

Thus, with detailed information regarding the user, the user's environment or status, more complex decisions can be made regarding the advertisement to display with the requested content. For example, if the user has previously specified that he prefers to see advertisements regarding hotels only when he has been traveling for an extended period of time, then the information from sensors like a GPS receiver and a speedometer sensor may be combined to determine that the user has been traveling for an extended period of time and based on that information and the user's previous selection selection, present advertisements regarding hotels for display on the user's interface. Alternatively, if for example a hotel wants its clients to observe advertisements regarding the hotel restaurant only after a particular time, then a sensor such as a clock, or timer, on the enhanced user content presenter may be used to select the appropriate advertisement for display on a hotel advertising display, for example a television in a guest room. Alternatively, if the user indicates he wants to see advertisements for laundry detergent when the contents of his laundry detergent box is below a certain level, a sensor such as a trip switch or a capacity sensor may be used to sense the contents of the user's laundry detergent box and to signal when the user's preferred type of advertising (i.e., laundry detergent advertisement) should be presented to the user. Thus, using a combination of sensors, and a selection of the user, a preferred advertisement is selected to be displayed with content.

Further, data in the user selection data base may be collected from other sources. For example, a computer interface on a user's refrigerator may keep track of the amount of milk remaining. Thus, if the user has indicated a selection for grocery advertisements or a particular grocer's advertisements when the level of milk has reached a particular level, than the appropriate grocery advertisement can be displayed when the condition specified by the user is satisfied.

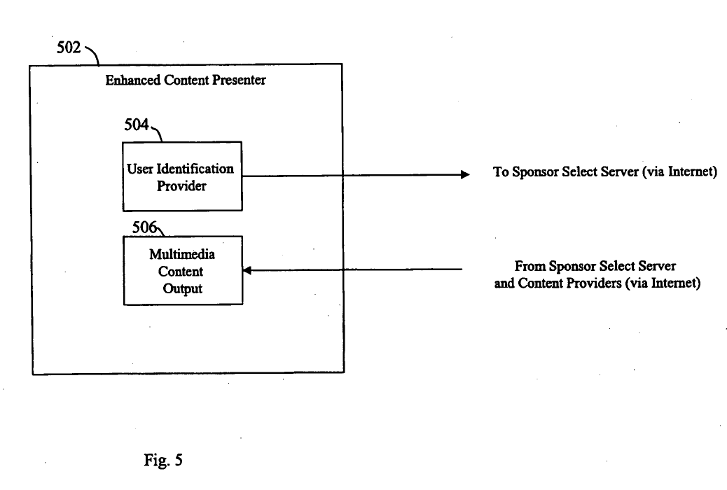

FIG. 5 shows an example of an enhanced content presenter 502 according to the present invention. Enhanced content presenter 502 includes a user identification provider 504 and a multimedia content output 506. The user identification provider 504 is similar to the user identification provider 204 described above for the user sponsor selector. The user identification provider 504 provides user identification information to the sponsor selector server 108 via the Internet. The sponsor select server uses the user identification information provided by user identification provider 504 to identify an advertisement to be displayed on the multimedia content output 506 according to information stored in the user database 122 and the advertiser database 110. The multimedia content output 506 presents content that the user has requested as well as advertisements selected according to selections of the user.

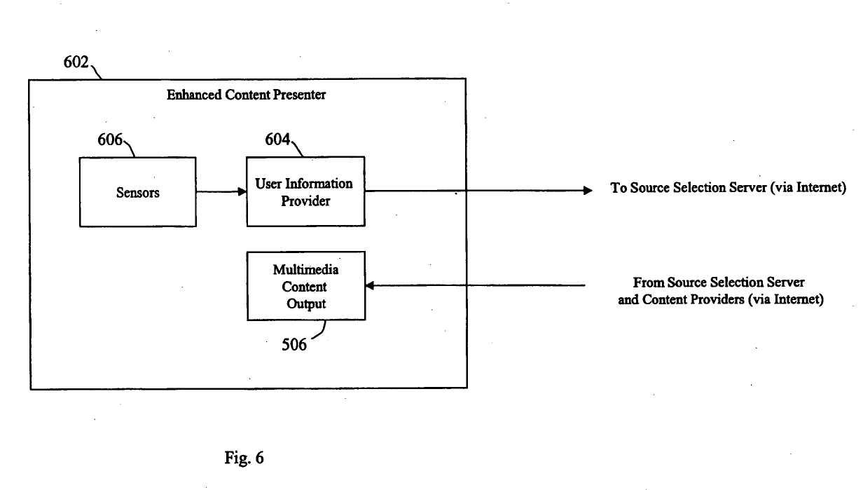

FIG. 6 shows an additional example of an enhanced content presenter according to the present invention. The enhanced content presenter 602 includes multimedia content output 506 as in the enhanced content presenter 502 of FIG. 5. However, the enhanced content presenter 602 also includes user information provider 604 and sensor 606. The user information provider 604 provides user identification of the user as performed by user identification provider 504 and the user information provider 604 also provides information regarding the user or the user's environment based on sensors 606. The user information including the user identification and sensor information is provided from the enhanced content presenter 602 to the sponsor select server 108 via the Internet so that a selection of an advertisement to be displayed on the multimedia content output 506 may be based upon user identification as well as the sensor data.

Further, sensor 606 may be a mechanical switch, a motion detector, and/or infrared or other wireless detection mechanism to ensure that the user (by virtue of his presence, or by actuation of buttons on a remote control) confirms his presence during the advertisement. While this example is given with regard to a television, other content may be used as well, such as for display on a navigation system on the dashboard of a vehicle. Likewise, Internet-based advertising or wireless handheld advertising are alternatives.

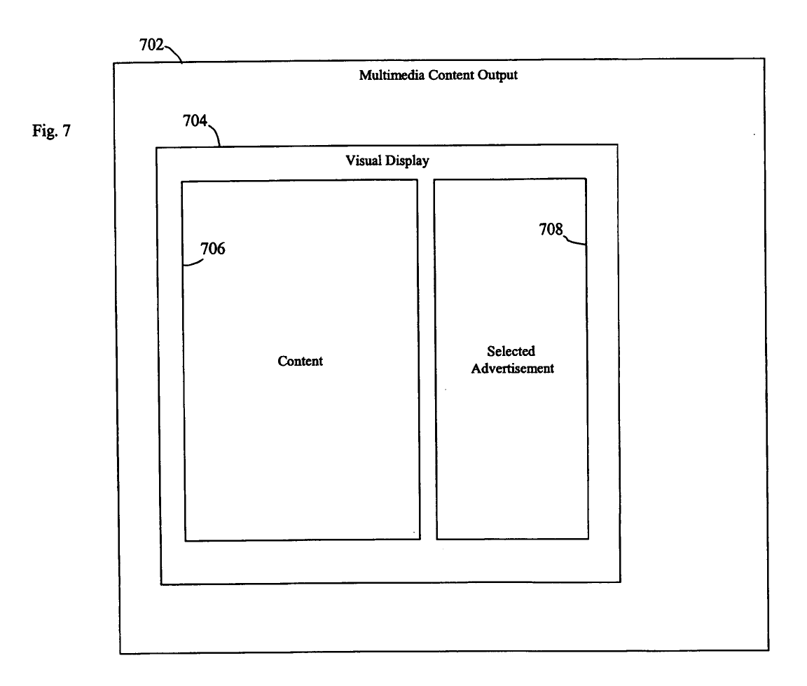

FIG. 7 shows an example of a multimedia content output 702 according to an embodiment of the present invention. Multimedia content output 702 includes a visual display 704 (e.g., a browser window on a computer or a page in a magazine). The visual display 704 shows content 706 and selected advertisement 708. Each of the content 706 and the selected advertisement 708 are visible on at least a portion of the visual display 704. In this example the content 706 is a content requested by a user and the selected advertisement 708 is an advertisement that is selected based on a selection of the user. Although the selected advertisement is shown as being separate from the content 706, one of skill in the art will know that selected advertisement may be superimposed on the content, for example, as a window placed over the content, or a banner advertisement in an Internet page placed alongside or around the requested content. One example of such an advertising graphical user interface is described in U.S. patent application Ser. No. 09/813,751, filed Mar. 21, 2001 entitled “Method for Enhancing the Effectiveness of Advertising Delivery Over Interactive Media”, the entire contents of which is incorporated herein by reference.

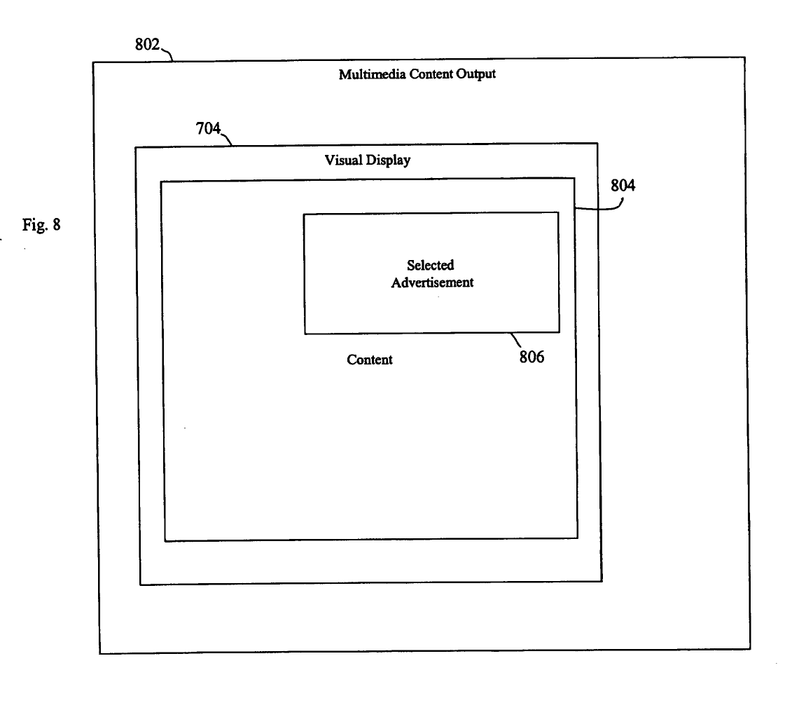

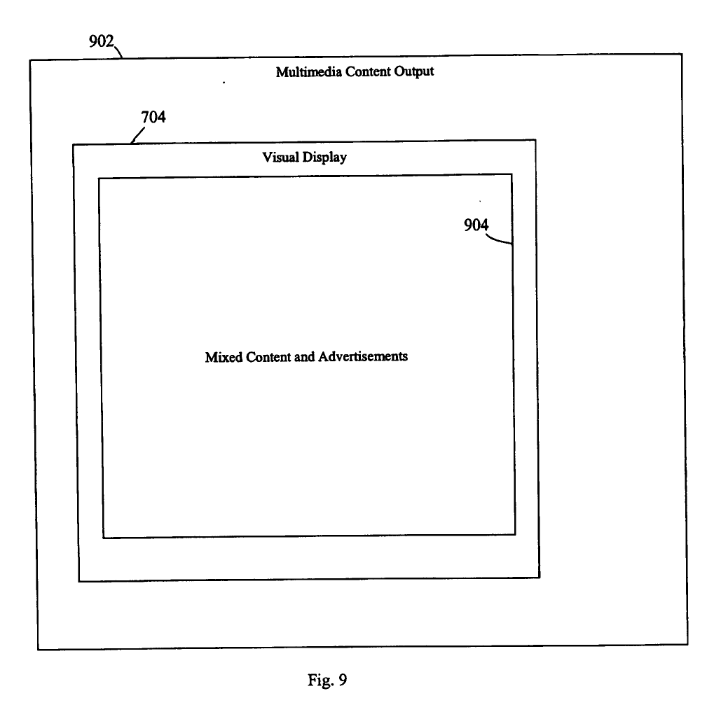

As a further example, as shown in FIG. 8, selected advertisement 806 may be superimposed over content 804. Alternatively, as shown in the example of FIG. 9, a mixed content and advertisement 904 may include both content and advertisements. Further, the display of content in advertisements is not limited to the examples shown and other possible combinations of advertisement and content are also included in the present invention.

One example of such mixed contents and advertisement is the case of product placement. In this situation, while viewing (e.g., in the context of television, or streaming video) particular objects within the video may be preidentified for displaying predetermined labels for certain products. As an example, an actor in one of the videos may be holding a beverage can, where the pixel field for the beverage can is identified in advance for use as an interface to advertisers. In particular, if for example a particular user identified Pepsi as a selected advertisement to sponsor the user's viewing of particular content, then the selection of that advertisement will result in the advertisement taking the form of a label overlaid on the beverage can during the display or production of video. This example of integrating content and advertisement is quite different than product placement in conventional movie technology, where the actor actually holds a particular beverage can of interest. In this situation it is the selection of the user that identifies the label (advertisement) that is to be presented on the product during the video program. Such advertisements are held in the advertiser database 110 (FIG. 1), where different candidate beverage sponsors have preformatted overlay advertisements that may be used in such product placement spots.

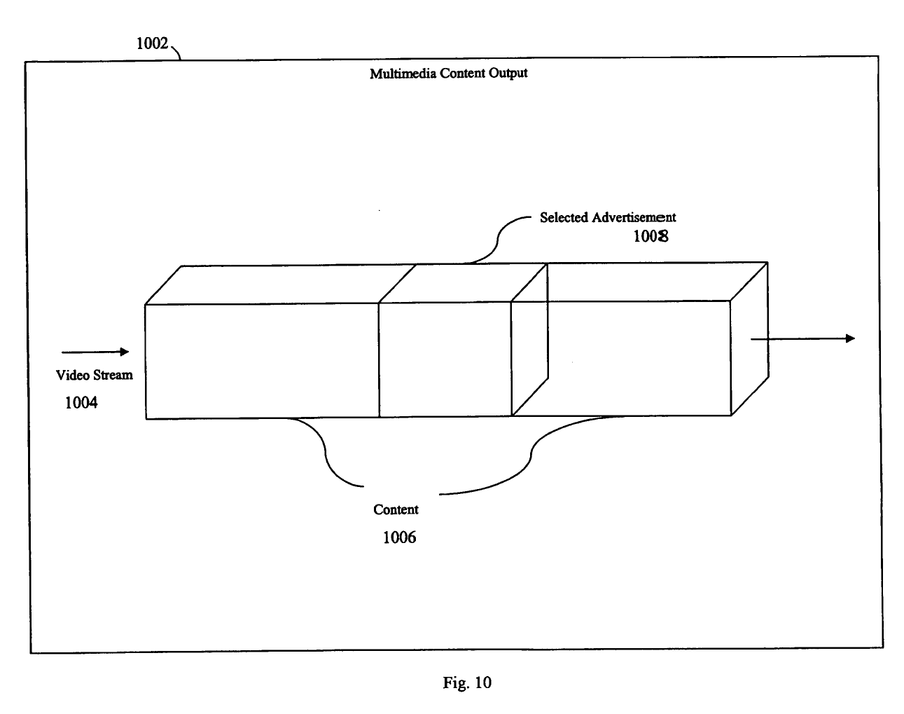

FIG. 10 shows an example of a multimedia content output 1002 that presents a video stream 1004 to the user. Video stream 1004 includes content 1006 and selected advertisement 1008. Thus, in the present example, video frames of content 1006 are intermixed with video of selected advertisement 1008 (e.g., an advertising video).

For example, the multimedia content output 1002 may be an example of a television set in a user's home, and video stream 1004 may be the video content on a particular channel which includes a desired program (e.g., content 1006) as well as advertisements selected by the user (e.g., selected advertisement 1008). Alternatively, multimedia content 1002 may be an example of a video display in a public area (e.g., on a public street or in an airport) that displays general content and also displays advertising selected for individuals that may be observing the multimedia content output based on selections made by those individuals and based on a means of identifying when those individuals are located near that multimedia content output. For example, a user may be identified using a radio signal scheme to identify the user to the multimedia content output device or by correlating a location of the user with a location of the multimedia content output device or by other means of associating a passerby/user with a particular multimedia content output. Alternatively, the multimedia content output 1002 may be an example of a portable device having a video and audio display, such as a PDA or portable computer or cell phone.

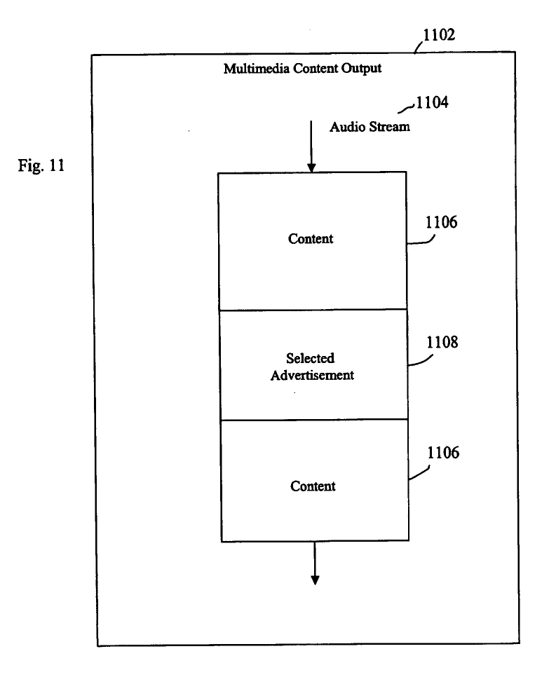

FIG. 11 shows a further possible embodiment of a multimedia content output according to the present invention. In this example, multimedia content output 1102 presents an audio stream 1104 which includes audio content 1106 and audio selected advertisement 1108.

For example, the multimedia content output 1102 may be a portable user radio listening device and audio stream 1104 may be an example of audio information broadcast from a particular terrestrial or satellite radio station. In addition, content 1106 may be an example of a particular audio program, for example a talk radio show, and selected advertisement 1108 may be an example of an audio advertisement presented during or in between breaks on the talk radio show.

Further, although multimedia content output examples are shown with visual display images, video streams and audio streams, a particular multimedia content output according to the present invention may include the presentation of combinations of these types of media as well as other types of media.

The user selection of certain sponsors may be used as an alternative to any type of subscription service (e.g., print media, TV, movies, video rentals, digital recorders, mobile phones, satellite radios, etc.). In this context, the service provider offers free of charge (or for a reduced fee) to the end user the service (e.g., satellite radio) in exchange for selecting particular sponsors to provide exclusive advertisements to the particular user. In the context of satellite radio, in exchange for providing free or reduced cost satellite services, the user selects a predetermined advertiser, and the advertisement is displayed on the user's satellite radio interface. Alternatively, in another context, in exchange for an advertiser to pay for a video rental service, the user agrees to observe a predetermined advertisement of any one of a variety of formats (as discussed above) in exchange for the payment of the subscription service.

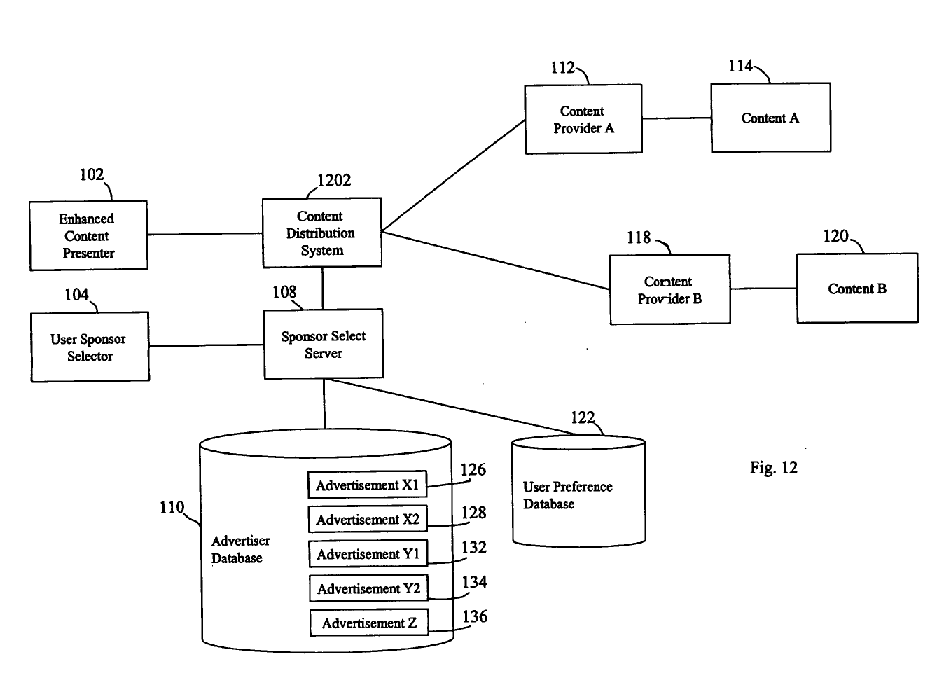

FIG. 12 shows a further possible embodiment of a system according to the present invention. The example of FIG. 12 is similar to the example of FIG. 1, however in the example of FIG. 12, the distribution of content to users is provided via a content distribution system 1202. Further, in this example the user sponsor 104 selector communicates directly with the sponsor select server or, alternatively may communicate with the sponsor select server via other communication means not shown (e.g., Internet, telephone, voice communication, mail, etc.).

Further, while the previous examples featured a content distribution scheme that used a “pull” paradigm in which users request particular content and thereby pull that content from content providers, the embodiment of FIG. 12 features an alternative paradigm in which content is distributed to users or “pushed” to users.

Thus, in the present embodiment, content and advertisements are distributed to users using a broadcast distribution scheme or other “push” communication systems (for example broadcast television or broadcast radio, or satellite television). Further, user advertising selections are used to select advertisements to be displayed in the multimedia displayed on the user's enhanced content presenter by inserting the preferred advertisement into a distribution channel intended for the user. Alternatively, the advertisement is encoded or provided with identification information that would allow a user to observe appropriate advertisements upon receipt.

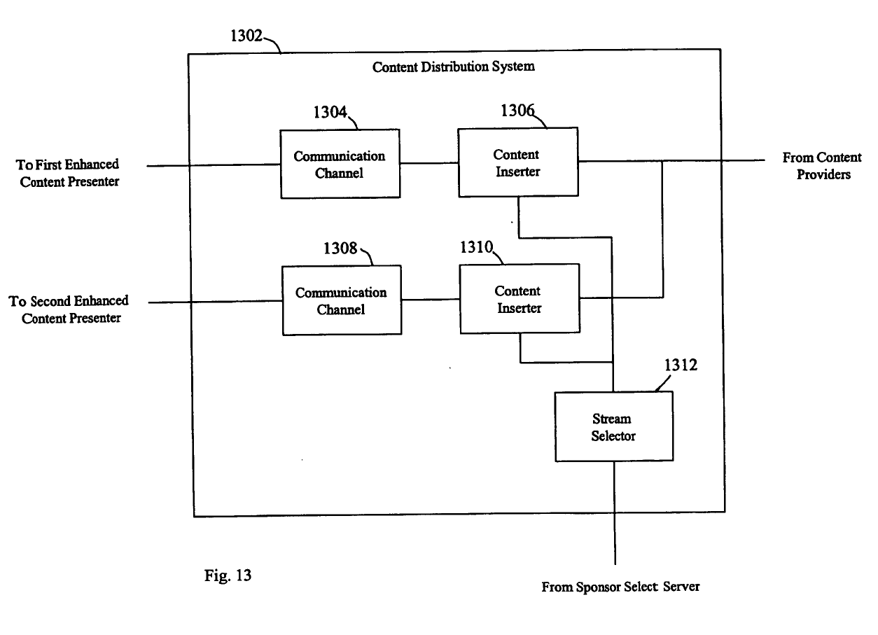

FIG. 13 shows an embodiment of a content distribution system 1302 according to this embodiment. In the content distribution system 1302, content inserters 1306 and 1310 receive content from content providers and combine that content with an advertisement as indicated by stream selector 1312 which receives the advertisement from the sponsor select server. Further, the combined content and advertisements are communicated to an appropriate enhanced content presenter using communication channels 1304 and 1308. For example, if a first user has indicated a selection for an advertisement (for example advertisement X1), then stream selector 1312 directs advertisement X1 to content inserter 1306 and content inserter 1306 adds advertisement X1 to content that is distributed to the first enhanced content presenter of the first user via communication channel 1304.

For example, in the system according to FIGS. 12 and 13, a user may employ a satellite radio receiver in his car as a first enhanced content presenter and the user may also employ a personal computer at his home as a second enhanced content presenter. Based on selections made by the user, the stream selector inserts advertisements that are appropriate for display on the user's satellite radio device using content inserter 1306 to be transmitted to the user using satellite radio bands as communication channel 1304. In addition, stream selector 1312 inserts advertisements that are appropriate for the user's home PC using content inserter 1310 to be distributed over the Internet as content communication channel 1308.

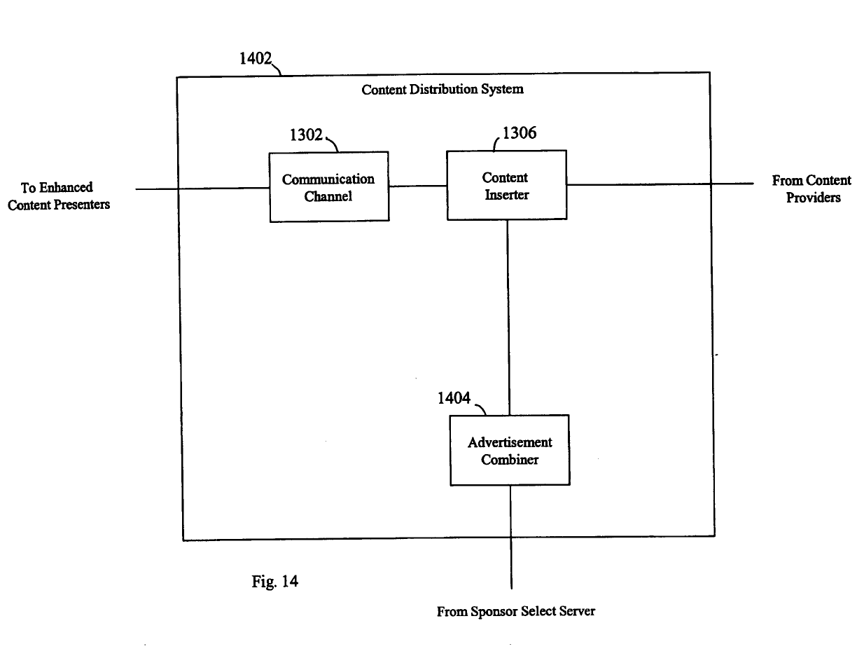

Thus, in the example of FIG. 13, content inserters 1306 and 1310 insert advertisements provided by stream selector 1312 into communication channel for subsequent presentation or display to a user. Alternatively, in the example FIG. 14, an advertisement combiner 1404 provides a combined advertisement to a content inserter 1306 for presentation to users via communication channel 1302. In particular, advertisement combiner 1404 groups together plural advertisements requested or indicated as desired by plural users and those plural advertisements are combined into the information transmitted to plural users via communication channel 1302.

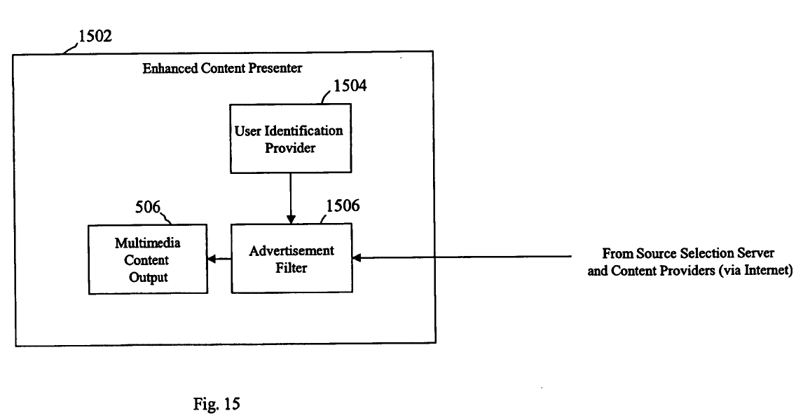

FIG. 15 shows an example of an enhanced contents presenter used to receive combined advertisements that are combined using advertisement combiner 1404 in the example of FIG. 14. In particular, FIG. 15 shows an example of an enhanced content presenter 1502 that includes multimedia content output 506 as described above. Further, enhanced content presenter 1502 also includes user identification provider 1504 connected to an advertisement filter 1506. The advertisement filter 1506 receives the content and combined advertisements provided by the content distribution system, for example the content distribution system 1402 of FIG. 14. The advertisement filter 1506 selects particular advertisements in the combined advertisements based on the user identification information from user identification provider 1504, and only sends to the multimedia content output 506 those advertisements that have been identified as being appropriate for this particular user. For example, if enhanced content presenter 1502 is an example of a television display in a user's home, then plural advertisements may be broadcast along with content and only those advertisements selected by the user are displayed based on the user identification in the television and an advertisement filter in the television. For example, even if the user indicates a selection for watching advertisements for soft drink “Brand X” on his home television, the source selection server and an advertisement combiner may include advertisements for both soft drink “Brand X” and soft drink “Brand Y” products in a television stream broadcast to the user's television. However, since the user indicated a selection for soft drink “Brand X” advertisements, when a commercial break is displayed in the television program that the user is watching (e.g., content), a soft drink “Brand X” advertisement will be displayed rather than a soft drink “Brand Y” advertisement according to the user's specified selections.

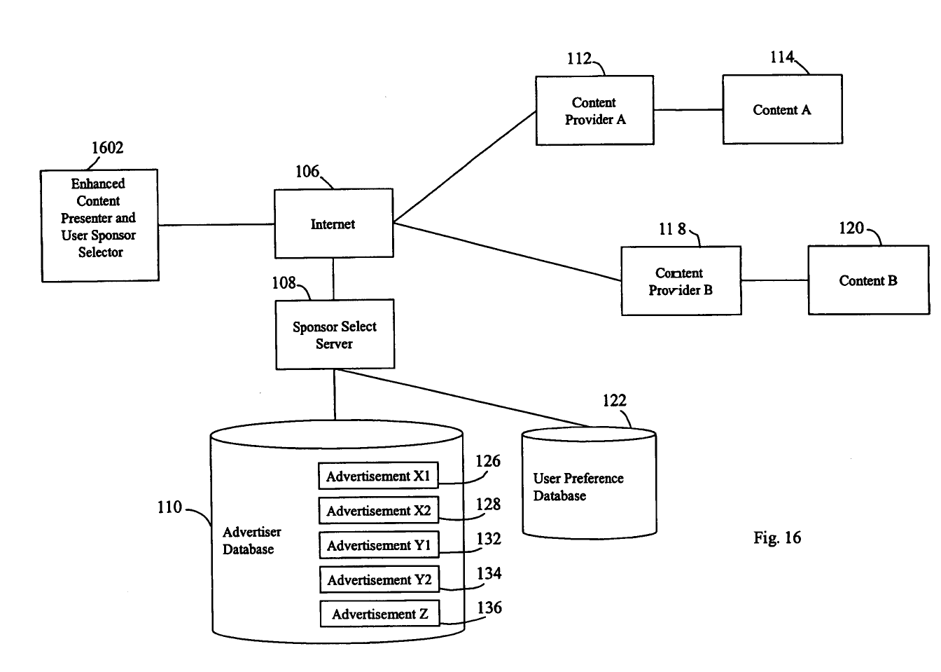

FIG. 16 shows an alternative embodiment of a system according to the present invention. The example shown in FIG. 16 is similar to the example shown in FIG. 1 however, the system of FIG. 16 includes an enhanced content presenter and user sponsor selector 1602 which combines the features of the enhanced content presenter 102 and the user sponsor selector 104 of FIG. 1 into a single device.

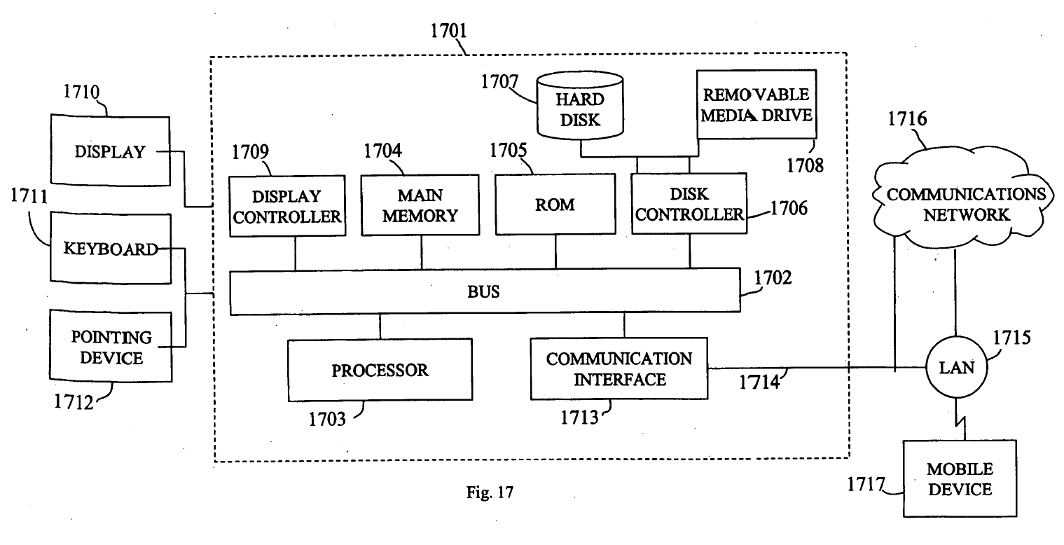

FIG. 17 illustrates a computer system 1701 upon which an embodiment of the present invention may be implemented. The computer system 1701 includes a bus 1702 or other communication mechanism for communicating information, and a processor 1703 coupled with the bus 1702 for processing the information. The computer system 1701 also includes a main memory 1704, such as a random access memory (RAM) or other dynamic storage device (e.g., dynamic RAM (DRAM), static RAM (SRAM), and synchronous DRAM (SDRAM)), coupled to the bus 1702 for storing information and instructions to be executed by processor 1703. In addition, the main memory 1704 may be used for storing temporary variables or other intermediate information during the execution of instructions by the processor 1703. The computer system 1701 further includes a read only memory (ROM) 1705 or other static storage device (e.g., programmable ROM (PROM), erasable PROM (EPROM), and electrically erasable PROM (EEPROM)) coupled to the bus 1702 for storing static information and instructions for the processor 1703.

The computer system 1701 also includes a disk controller 1706 coupled to the bus 1702 to control one or more storage devices for storing information and instructions, such as a magnetic hard disk 1707, and a removable media drive 1708 (e.g., floppy disk drive, read-only compact disc drive, read/write compact disc drive, compact disc jukebox, tape drive, flash memory drive, and removable magneto-optical drive). The storage devices may be added to the computer system 1701 using an appropriate device interface (e.g., small computer system interface (SCSI), integrated device electronics (IDE), enhanced-IDE (E-IDE), direct memory access (DMA), or ultra-DMA).

The computer system 1701 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1701 may also include a display controller 1709 coupled to the bus 1702 to control a display 1710, such as a cathode ray tube (CRT), for displaying information to a computer user. The computer system includes input devices, such as a keyboard 1711 and a pointing device 1712, for interacting with a computer user and providing information to the processor 1703. The pointing device 1712, for example, may be a mouse, a trackball, or a pointing stick for communicating direction information and command selections to the processor 1703 and for controlling cursor movement on the display 1710. In addition, a printer may provide printed listings of data stored and/or generated by the computer system 1701.

The computer system 1701 performs a portion or all of the processing steps of the invention in response to the processor 1703 executing one or more sequences of one or more instructions contained in a memory, such as the main memory 1704. Such instructions may be read into the main memory 1704 from another computer readable medium, such as a hard disk 1707 or a removable media drive 1708. One or more processors in a multi-processing arrangement may also be employed to execute the sequences of instructions contained in main memory 1704. In alternative embodiments, hard-wired circuitry may be used in place of or in combination with software instructions. Thus, embodiments are not limited to any specific combination of hardware circuitry and software.

As stated above, the computer system 1701 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1701, for driving a device or devices for implementing the invention, and for enabling the computer system 1701 to interact with a human user (e.g., print production personnel). Such software may include, but is not limited to, device drivers, operating systems, development tools, and applications software. Such computer readable media further includes the computer program product of the present invention for performing all or a portion (e.g., locally portion of distributed processing) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed or centralized for better performance, reliability, and/or cost.

The term “computer readable medium” as used herein refers to any medium that participates in providing instructions to the processor 1703 for execution. A computer readable medium may take many forms, including but not limited to, non-volatile media, volatile media, and transmission media. Non-volatile media includes, for example, optical, magnetic disks, flash memory, and magneto-optical disks, such as the hard disk 1707 or the removable media drive 1708. Volatile media includes dynamic memory, such as the main memory 1704. Transmission media includes coaxial cables, copper wire and fiber optics, including the wires that make up the bus 1702. Transmission media also may also take the form of acoustic or light waves, such as those generated during radio wave and infrared data communications.

Various forms of computer readable media may be involved in carrying out one or more sequences of one or more instructions to processor 1703 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1701 may receive the data on the telephone line and use an infrared transmitter to convert the data to an infrared signal. An infrared detector coupled to the bus 1702 can receive the data carried in the infrared signal and place the data on the bus 1702. The bus 1702 carries the data to the main memory 1704, from which the processor 1703 retrieves and executes the instructions. The instructions received by the main memory 1704 may optionally be stored on storage device 1707 or 1708 either before or after execution by processor 1703.

The computer system 1701 also includes a communication interface 1713 coupled to the bus 1702. The communication interface 1713 provides a two-way data communication coupling to a network link 1714 that is connected to, for example, a local area network (LAN) 1015, or to another communications network 1716 such as the Internet. For example, the communication interface 1713 may be a network interface card to attach to any packet switched LAN. As another example, the communication interface 1713 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1713 sends and receives electrical, electromagnetic or optical signals that carry digital data streams representing various types of information.

The network link 1714 typically provides data communication through one or more networks to other data devices. For example, the network link 1714 may provide a connection to another computer through a local network 1715 (e.g., a LAN) or through equipment operated by a service provider, which provides communication services through a communications network 1716. The local network 1714 and the communications network 1716 use, for example, electrical, electromagnetic, or optical signals that carry digital data streams, and the associated physical layer (e.g., CAT 5 cable, coaxial cable, optical fiber, etc). The signals through the various networks and the signals on the network link 1714 and through the communication interface 1713, which carry the digital data to and from the computer system 1701 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1701 can transmit and receive data, including program code, through the network(s) 1715 and 1716, the network link 1714 and the communication interface 1713. Moreover, the network link 1714 may provide a connection through a LAN 1715 to a mobile device 1717 such as a personal digital assistant (PDA) laptop computer, or cellular telephone.

Obviously, numerous modifications and variations of the present invention are possible in light of the above teachings. It is therefore to be understood that within the scope of the appended claims, the invention may be practiced otherwise than as specifically described herein.

1. A computer-implemented method of presenting a multimedia content, comprising steps of:
receiving and storing in memory an advertisement selection of a user, said advertisement selection including at least one user preferred advertising source;
selecting a user preferred advertisement based on the at least one user preferred advertising source; and
retrieving from memory and presenting the user preferred advertisement and the multimedia content to the user.

2. The method of claim 1, wherein the receiving step further comprises:
informing the user of more than one offered advertising source, said more than one offered advertising source including the at least one user preferred advertising source; and
detecting a user action that selects the at least one user preferred advertising source.

3. The method of claim 1, wherein the advertisement selection of the user further includes an identification information of the user.

4. The method of claim 1, wherein the advertisement selection of the user further includes an identification information of a user interface used by the user.

5. The method of claim 1, wherein the selecting step further comprises:
generating a sensor data that includes at least one of a current location of the user, a location of the user at a time the user action is detected, a detected environmental characteristic, a detected movement, and a received signal; and
selecting the user preferred advertisement based on the sensor data.

6. The method of claim 2, wherein the informing step further comprises:
presenting to the user at least one of each available advertisement, a reduced representation of each available advertisement, a category of each available advertisement, and a sponsor associated with each available advertisement.

7. The method of claim 2, wherein the detecting step further comprises:
detecting a preferred condition for presenting the user preferred advertisement, said preferred condition including at least one of a time of day of presenting the advertisement, a location of presenting the advertisement, and a category of a preferred advertisement,
wherein at least one of the selecting step and the presenting step is based on satisfaction of the preferred condition.

8. The method of claim 1, wherein the presenting step further comprises at least one of visually displaying the multimedia content, visually displaying the advertising content, audibly presenting the multimedia content, and audibly presenting the advertising content.

9. The method of claim 1, wherein the presenting step further comprises:
identifying a replacement object in the multimedia content, the replacement object including one or more visual or audio portions of the multimedia content; and
inserting an appropriate representation of the user preferred advertisement into the replacement object.

10. The method of claim 1, wherein the presenting step further comprises:
sending an unselected advertisement and the user preferred advertisement to a user display; and
preventing the presentation of the unselected advertisement from the user display.

11. A server for control of advertising to a user, said server comprising:
a receiving section configured to receive an advertisement selection of the user from a user sponsor selector, said advertisement selection including at least one user preferred advertising source;
a selecting section configured to select a user preferred advertisement based on the at least one user preferred advertising source; and
a sending section configured to send the user preferred advertisement to a content presenter for presentation to the user.

12. The server of claim 11, wherein the receiving section further comprises:
an available advertisement sending section configured to send more than one advertising source to the user sponsor selector, said more than one offered advertising source including the at least one user preferred advertising source; and
a user preferred advertising source receiver configured to receive at least one user preferred advertising source detected by the user sponsor selector.

13. The server of claim 11, wherein the advertisement selection of the user further includes an identification information of the user.

14. The server of claim 11, wherein the advertisement selection of the user further includes an identification information of a user interface used by the user.

15. The server of claim 11, wherein the selecting section further comprises:
a sensor data receiving section configured to receive a sensor data from at least one of the user sponsor selector and the user content presenter, said sensor data including at least one of a current location of the user, a location of the user at a time the user action is detected, a detected environmental characteristic, a detected movement, and a received signal,
wherein the selecting section is further configured to select the user preferred advertisement based on the sensor data.

16. The server of claim 12, wherein the available advertisement sending section is further configured to send at least one of each available advertisement, a reduced representation of each available advertisement, a category of each available advertisement, and a sponsor associated with each available advertisement to the user sponsor selector.

17. The server of claim 12, wherein the user preferred advertising source receiver further comprises:
a preferred condition receiving section for receiving a preferred condition for presenting the user preferred advertisement from the sponsor sector, said preferred condition including at least one of a time of day of presenting the advertisement, a location of presenting the advertisement, and a category of a preferred advertisement,
wherein at least one of the selecting section configured to select the user preferred advertisement and the sending section configured to send the user preferred advertisement is configured to respectively select or send based on satisfaction of the preferred condition.

18. The method of claim 11, wherein the sending section is further configured to send the user preferred advertisement and the multimedia content to the content presenter sending at least one of a visually displayed multimedia content, a visually displayed advertising content, an audibly presented multimedia content, and an audibly presented advertising content.

19. The server of claim 11, further comprising:
a replacement identifying section configured to identify a replacement object in the multimedia content, the replacement object including one or more visual or audio portions of the multimedia content; and
an inserting section configured to insert an appropriate representation of the user preferred advertisement into the replacement object.

20. The server of claim 11, wherein the sending section is further configured to send an unselected advertisement, the user preferred advertisement, and an information regarding a user selection so that the unselected advertisement is not presented on the content presenter.

21. An apparatus for a user to select a sponsor, said apparatus comprising:
a user identification section configured to obtain information identifying the user; and
a sponsor selecting section configured to send an advertisement selection of the user to a server, the advertisement selection including at least one user preferred advertising source selected by the user and the information identifying the user to the server for selecting a user preferred advertisement based on the at least one user preferred advertising source and presenting the user preferred advertisement and a multimedia content on a content presenter.

22. The apparatus of claim 21, further comprising:
an offered sponsors section configured to present more than one offered advertising source to the user, said more than one offered advertising source including the at least one user preferred advertising source; and
a user action detection section configured to detect a user action that selects the at least one user preferred advertising source.

23. The apparatus of claim 21, wherein the advertisement selection of the user further includes an identification information of the user.

24. The apparatus of claim 21, wherein the advertisement selection of the user further includes an identification information of at least one of the apparatus and the content presenter.

25. The apparatus of claim 21, further comprising:
a sensor configured to produce sensor data that includes at least one of a location of the user at a time the user action is detected, a detected environmental characteristic, a detected movement, and a received signal, wherein the sponsor selecting section is further configured to send the sensor data to the server.

26. The apparatus of claim 22, wherein the more than one offered advertising source includes at least one of each available advertisement, a reduced representation of each available advertisement, a category of each available advertisement, and a sponsor associated with each available advertisement.

27. The apparatus of claim 22, wherein the user action detection section is further configured to obtain a preferred condition for presenting the user preferred advertisement, said preferred condition including at least one of a time of day of presenting the advertisement, a location of presenting the advertisement, and a category of a preferred advertisement, and to send the obtained preferred condition to the server,
wherein at least one of the selecting the user preferred advertisement by the server and the presenting the user preferred advertisement and the multimedia content by the content presenter is based on satisfaction of the preferred condition.

28. A content presenting apparatus comprising:
a multimedia output section configured to present a user preferred advertisement and a multimedia content from a server;
a sensor configured to detect sensor data including at least one of a current location of the user, a location of the user at a time the user action is detected, a detected environmental characteristic, a detected movement, and a received signal; and
a user identification section configured to send an information identifying a user and the sensor data to the server for use in selecting the user preferred advertisement for display on the apparatus.

29. The apparatus of claim 28, further comprising an apparatus identifying section configured to send an identification information of the apparatus to the server.

30. The apparatus of claim 28, furthering comprising:
a preferred condition detecting section configured to detect a preferred condition for presenting the user preferred advertisement, said preferred condition including at least one of a time of day of presenting the advertisement, a location of presenting the advertisement, and a category of a preferred advertisement,
wherein the multimedia output section is further configured to present at least one of the user preferred advertisement and the multimedia content based on satisfaction of the preferred condition.

31. The apparatus of claim 28, wherein the multimedia output section further comprises:
a visual display configured to present at least one of a visually displayed multimedia content, and a visually displayed advertising content; and
an audio presenter configured to present at least one of an audibly presented multimedia content, and an audibly presented advertising content.

32. The apparatus of claim 28, further comprising:
a replacement identifying section configured to identify a replacement object in the multimedia content, the replacement object including one or more visual or audio portions of the multimedia content; and
an object inserting section configured to insert an appropriate representation of the user preferred advertisement into the replacement object for presentation to the user.

33. The apparatus of claim 28, further comprising an unselected advertisement filter configured to prevent the presentation of an unselected advertisement to the user.

34. A computer program product having computer program instructions which when executed by a computer cause the computer to perform the following steps:
receiving and storing in memory an advertisement selection of a user, said advertisement selection including at least one user preferred advertising source;
selecting a user preferred advertisement based on the at least one user preferred advertising source; and
retrieving from memory and presenting the user preferred advertisement and the multimedia content to the user.

35. The computer program product of claim 34, further including instructions causing the computer to perform steps of:
informing the user of more than one offered advertising source, said more than one offered advertising source including the at least one user preferred advertising source; and
detecting a user action that selects the at least one user preferred advertising source.

36. The computer program product of claim 34, wherein the advertisement selection of the user further includes an identification information of the user.

37. The computer program product of claim 34, wherein the advertisement selection of the user further includes an identification information of a user interface used by the user.

38. The computer program product of claim 34, wherein the selecting step further comprises:
generating a sensor data that includes at least one of a current location of the user, a location of the user at a time the user action is detected, a detected environmental characteristic, a detected movement, and a received signal; and
selecting the user preferred advertisement based on the sensor data.

39. The computer program product of claim 35, wherein the informing step further comprises:
presenting to the user at least one of each available advertisement, a reduced representation of each available advertisement, a category of each available advertisement, and a sponsor associated with each available advertisement.

40. The computer program product of claim 35, wherein the detecting step further comprises:
detecting a preferred condition for presenting the user preferred advertisement, said preferred condition including at least one of a time of day of presenting the advertisement, a location of presenting the advertisement, and a category of a preferred advertisement,
wherein at least one of the selecting step and the presenting step is based on satisfaction of the preferred condition.

41. The computer program product of claim 34, wherein the presenting step further comprises at least one of visually displaying the multimedia content, visually displaying the advertising content, audibly presenting the multimedia content, and audibly presenting the advertising content.

42. The computer program product of claim 34, wherein the presenting step further comprises:
identifying a replacement object in the multimedia content, the replacement object including one or more visual or audio portions of the multimedia content; and
inserting an appropriate representation of the user preferred advertisement into the replacement object.

43. The computer program product of claim 34, wherein the presenting of the user preferred advertisement and the multimedia content further comprises:
sending an unselected advertisement and the user preferred advertisement to a user display; and
preventing the presentation of the unselected advertisement from the user display.

44. A system for presenting a user selected advertisement, said system comprising:
means for obtaining an advertisement selection of the user, said advertisement selection including at least one user preferred advertising source;
means for receiving the advertisement selection of the user from the sponsor selector and selecting a user preferred advertisement based on the at least one user preferred advertising source; and
means for presenting the user preferred advertisement and the multimedia content to the user.
